(19) United States
(12) Patent Application Publication
(10) Pub. No.: US 2026/0299629 A1
(43) Pub. Date: Oct. 1, 2026

(54) LOW VOLTAGE SOLUTION FOR ZENER VOLTAGE REFERENCE

(71) Applicant: STMicroelectronics International N.V., Geneva (CH)

(72) Inventors: Sandro Rossi, Pavia (IT); Andrea Gambero, Santo Stefano Ticino (IT); Lorenzo Rosati, Borgolavezzaro (IT)

(21) Appl. No.: 19/097,728

(22) Filed: Apr. 1, 2025

(51) Int. Cl. G05F 3/18

(52) U.S. Cl. CPC G05F 3/185

(57) ABSTRACT

A voltage reference circuit includes: a Zener diode and a synchronization circuit coupled to a cathode of the Zener diode. The synchronization circuit includes a first circuit and a second circuit, where each of the first circuit and second circuit includes: a current source coupled between a supply voltage node and a first node; a first switch coupled between the first node and a reference voltage node; a first capacitor coupled between the first node and a second node; a second switch coupled between the second node and the supply voltage node; and a third switch coupled between the second node and the cathode of the Zener diode.

### TECHNICAL FIELD

The present invention relates generally to voltage reference circuits, and in particular embodiments, to Zener voltage reference circuits.

### BACKGROUND

Modern electronic systems rely on stable and accurate voltage references for proper operation. A voltage reference circuit provides an output voltage that remains substantially stable across variations in temperature, supply voltage, and other operating conditions.

Various types of voltage reference circuits have been developed. For example, a bandgap voltage reference circuit combines the negative temperature coefficient of a forward-biased p-n junction with the positive temperature coefficient of another circuit element to achieve improved temperature stability, and provides a reference voltage related to the silicon bandgap energy. As another example, a Zener voltage reference circuit uses a Zener diode to generate a reference voltage equal to the breakdown voltage of the Zener diode. Zener voltage reference circuits may be preferred to bandgap voltage reference circuits in applications where low Long Term Drift (LTD) is required, because it is more immune to piezoelectric effect induced by mechanical stress. Challenges remain in the design of Zener voltage reference circuits.

### SUMMARY

In an embodiment, a voltage reference circuit includes: a Zener diode and a synchronization circuit coupled to a cathode of the Zener diode. The synchronization circuit includes a first circuit and a second circuit, where each of the first circuit and second circuit includes: a current source coupled between a supply voltage node and a first node; a first switch coupled between the first node and a reference voltage node; a first capacitor coupled between the first node and a second node; a second switch coupled between the second node and the supply voltage node; and a third switch coupled between the second node and the cathode of the Zener diode.

In an embodiment, a voltage reference circuit includes: a synchronization circuit, wherein the synchronization circuit comprises a plurality of sub-circuits, wherein each of the sub-circuits comprises: a current source coupled between a supply voltage node and a first node; a first switch coupled between the first node and a reference voltage node; a capacitor coupled between the first node and a second node; a second switch coupled between the second node and the supply voltage node; and a third switch coupled between the second node and an output terminal of the synchronization circuit. The voltage reference circuit further includes a Zener diode coupled between the output terminal of the synchronization circuit and the reference voltage node.

In an embodiment, a method of operating a voltage reference circuit is disclosed. The voltage reference circuit comprises a synchronization circuit and a Zener diode coupled to an output terminal of the synchronization circuit, where the synchronization circuit comprises a plurality of sub-circuits. The method includes: setting the plurality of sub-circuits in a first operating mode for a first duration of time, wherein each of the sub-circuits comprises: a current source coupled between a supply voltage and a first node; a first switch coupled between the first node and a reference voltage; a capacitor coupled between the first node and a second node; a second switch coupled between the second node and the supply voltage; and a third switch coupled between the second node and the output terminal of the synchronization circuit, wherein setting the plurality of sub-circuits in the first operating mode comprises, for each of the plurality of sub-circuits, closing the first switch and the second switch and opening the third switch. The method further includes, after the first duration of time elapses, switching each of the plurality of sub-circuits between the first operating mode and a second operating mode alternately, wherein each of the plurality of sub-circuits is set in the second operating mode by opening the first switch and the second switch and closing the third switch.

### BRIEF DESCRIPTION OF THE DRAWINGS

The details of one or more embodiments of the invention are set forth in the accompanying drawings and the description below. Other features, objects, and advantages of the invention will be apparent from the description and drawings, and from the claims. In the figures, the same or similar reference numerals or symbols generally designate the same or similar component parts throughout the various views, which will generally not be re-described in the interest of brevity. For a more complete understanding of the invention, reference is now made to the following descriptions taken in conjunction with the accompanying drawings, in which:

FIGS. 1-3 illustrate a Zener voltage reference circuit in different operational stages, in an embodiment;

FIG. 4 illustrates the current-voltage (CV) characteristics of a current source, in an embodiment;

FIG. 5 illustrates the transition of the operating modes of the sub-circuits of the Zener voltage reference circuit of FIGS. 1-3 in different operational stages, in an embodiment;

FIG. 6 illustrates a timing diagram of the Zener voltage reference circuit of FIGS. 1-3, in an embodiment;

FIG. 7 illustrates a Zener voltage reference circuit, in another embodiment;

FIG. 8 illustrates the transition of the operating modes of the sub-circuits of the Zener voltage reference circuit of FIG. 7 in different operational stages, in an embodiment;

FIG. 9 illustrates a timing diagram of the Zener voltage reference circuit of FIG. 7, in an embodiment;

FIG. 10 illustrates a sub-circuit of a Zener voltage reference circuit, in an embodiment;

FIG. 11 illustrates a sub-circuit of a Zener voltage reference circuit, in another embodiment;

FIG. 12 illustrates a sub-circuit of a Zener voltage reference circuit, in yet another embodiment;

FIG. 13 illustrates a Zener voltage reference circuit with temperature compensation capability, in an embodiment; and

FIG. 14 illustrates an analog-to-digital converter (ADC) system using a Zener voltage reference circuit, in an embodiment.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described in the context of voltage reference circuits, and in particular embodiments, to Zener voltage reference circuits.

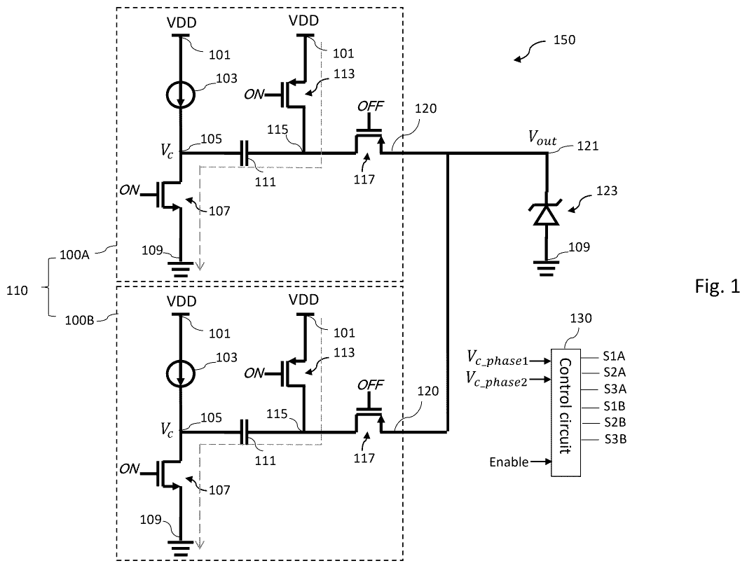

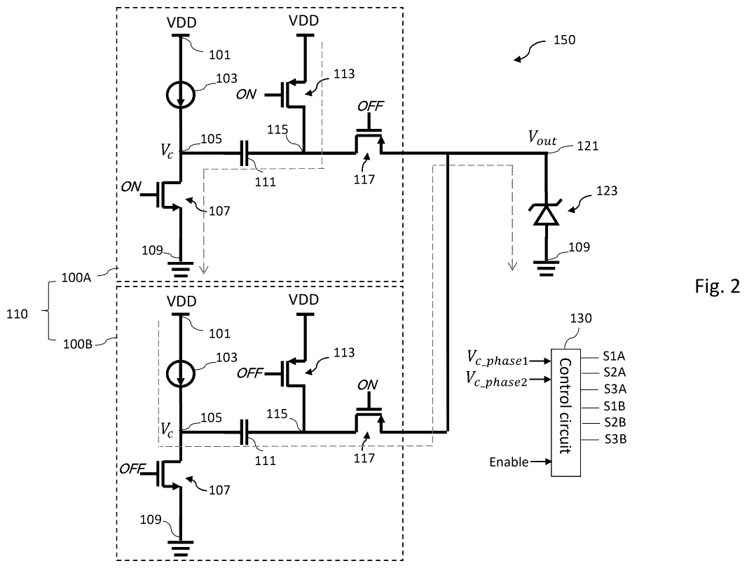

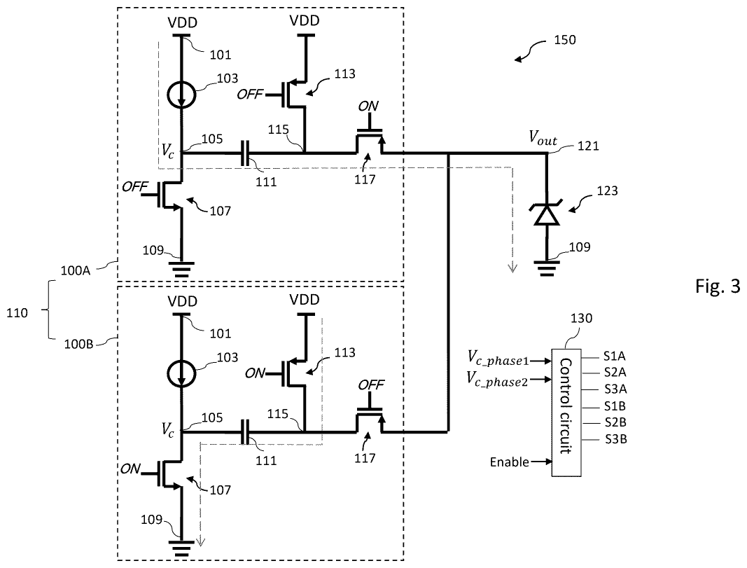

FIGS. 1-3 illustrate a Zener voltage reference circuit 150 in different operational stages, in an embodiment. In particular, FIG. 1 illustrates the Zener voltage reference circuit 150 in a startup stage, e.g., after the Zener voltage reference circuits 150 powers up. FIGS. 2-3 illustrate the Zener voltage reference circuit 150 in a switching stage, where each sub-circuit 100A or 100B of the Zener voltage reference circuits 150 switches between a first operating mode (also referred to as charging mode) and a second operating mode (also referred to as Zener mode) alternately. Details are discussed hereinafter.

Referring now to FIG. 1, the Zener voltage reference circuit 150 includes a sub-circuit 100A, a sub-circuit 100B, a control circuit 130, and a Zener diode 123. In the illustrated embodiments, the sub-circuits 100A and 100B may have the same structure. For example, the sub-circuits 100A and 100B may be formed using the same components with the same electrical connections. In other words, the sub-circuits 100A and 100B are instantiations of a same sub-circuit design. The sub-circuits 100A and 100B are controlled by control signals generated by the control circuit 130, and may each operate in the first operating mode or the second operating mode. The sub-circuits 100A and 100B may also be referred to as a first circuit 100A and a second circuit 100B, respectively, or a Phase1 circuit and a Phase2 circuit, respectively, in the discussion herein. In addition, the sub-circuits 100A and 100B are collectively referred to as a synchronization circuit 110 of the Zener voltage reference circuit 150.

As illustrated in FIG. 1, the sub-circuit 100A (or 100B) includes a current source 103 coupled between a supply voltage node 101 and a node 105. The supply voltage node 101 is coupled to a supply voltage V_{DD} during operation of the Zener voltage reference circuit 150. The current source 103 may be, e.g., a current mirror circuit. Current mirror circuits are known and used in the art, thus details are not discussed here.

In each of the sub-circuit 100A (or 100B) in FIG. 1, a switch 107 is coupled between the node 105 and a reference voltage node 109. The reference voltage node 109 is coupled to a reference voltage, such as electrical ground, during operation of the Zener voltage reference circuit 150. A capacitor 111 is coupled between the node 105 and a node 115. A switch 113 is coupled between the node 115 and the supply voltage node 101. A switch 117 is coupled between the node 115 and an output terminal 120 of the sub-circuit.

The output terminals 120 of the sub-circuits 110A and 100B are coupled to an output terminal 121 of the synchronization circuit 11o. The output terminal 121 is also referred to as the output terminal of the Zener voltage reference circuit 150. The cathode of the Zener diode 123 is coupled to the output terminal 121. The anode of the Zener diode 123 is coupled to the reference voltage node 109 (e.g., electrical ground).

The switches 107, 113, and 117 may be any suitable switches that can be controlled by the control signals from the control circuit 130. For example, the switches 107, 113, and 117 may be transistors, such as Complementary Metal-Oxide-Semiconductor (CMOS) transistors. Therefore, the switches 107, 113, and 117 may also be referred to as transistors 107, 113, and 117 in the discussion herein, with the understanding that other suitable types of switches may also be used. In the illustrated embodiments, the switch 107 is an N-type CMOS transistor, and the switches 113 and 117 are P-type CMOS transistors. The gate terminals of the transistors 107, 113, and 117 may also be referred to as the control terminals of the switches 107, 113, and 117. The source terminal and the drain terminal of each of the transistors 107, 113, and 117 may be collectively referred to as the load path terminals of the respective transistor. In the discussion herein, when the switch 107 (or 113, or 117) is said to be closed, this means the corresponding transistor 107 (or 113, or 117) is turned on, thus allowing an electrical current to flow through its load path terminals with little to no electrical resistance. When the switch 107 (or 113, or 117) is said to be open, this means the corresponding transistor 107 (or 113, or 117) is turned off, and the electrical path between its load path terminals has a very high electrical resistance, thus prohibiting electrical current from flowing through its load path terminals (except for, e.g., some leakage current which is negligible).

In some embodiments, the control circuit 130 is a circuit formed of logic gates connected together, where the logic gates may be, e.g., comparators, combinatorial logic gates, sequential logic gates, or the like. In some embodiments, the control circuit 130 is a micro-controller with memory modules. The memory modules may store computer code which, when executed by the micro-controller, implement various control functions for the Zener voltage reference circuit 150 by generating the control signals for the sub-circuits 100A and 100B. In some embodiments, the control circuit 130 takes as inputs the voltages V_{C} at the nodes 105 of the sub-circuits 100A and 100B and an enable signal, and generates control signals for the sub-circuits 100A and 100B, more details are discussed hereinafter. Note that in FIG. 1, the voltage V_{C} of the sub-circuit 100A and the voltage V_{C} of the sub-circuit 100B sent to the input terminals of the control circuit 130 are denoted as V_{C_phase1} and V_{C_phase2}, respectively. The enable signal (also referred to as switching enable signal) is a control signal used to control the operational stage of the Zener voltage reference circuit. FIG. 1 illustrates two sets of control signals, e.g., S1A, S2A, and S3A for connecting to the control terminals of the switches 107, 113, and 117 of the sub-circuit 100A, and S1B, S2B, and S3B for connecting to the control terminals of the switches 107, 113, and 117 of the sub-circuit 100B.

FIG. 1 illustrates the Zener voltage reference circuit 150 in the startup stage, which is the operational stage the Zener voltage reference circuit 150 enters after powering up or a after a reset. In the startup stage, both sub-circuits 100A and 100B are in a first operating mode (also referred to as charging mode). The control circuit 130 sets both sub-circuits 100A and 100B in the first operating mode by controlling the states (e.g., closed or open) of the switches 107, 113 and 117. In particular, when a sub-circuit (e.g., 100A or 100B) is in the first operating mode, the switches 107 and 113 in the sub-circuit are closed, and the switch 117 in the sub-circuit is open. As a result, for each sub-circuit 100A or 100B, an electrical current (see the dashed line inside the sub-circuit 100A or 100B) flows from the supply voltage V_{DD}, through the switch 113, the capacitor 111, and the switch 107 toward the reference voltage (e.g., electrical ground). The capacitor 111 is charged by the electrical current, and a voltage across the capacitor 111 (e.g., between the right-side terminal and the left-side terminal of the capacitor 111 in FIG. 1) increases to the supply voltage V_{DD} as electrical charge accumulates on the capacitor 111. The charging current through the capacitor 111 may stop once the voltage across the capacitor 111 reaches the supply voltage V_{DD}, as skilled artisans readily appreciate. A voltage V_{C} at the node 105 of each sub-circuit 100A or 100B is pulled down to electrical ground, due to the switch 107 being closed in the first operating mode. Note that since the switch 117 in each sub-circuit 100A or 100B is open during the first operating mode, the Zener diode 123 is disconnected from the synchronization circuit 110, no current flows through the Zener diode 123, and the voltage at the output terminal 121 is zero.

In embodiments where the switches 107, 113 and 117 are transistors, the control circuit 130 controls the states (e.g., closed or open) of the switches 107, 113 and 117 by applying control signals at the control terminals (e.g., gate terminals) of the transistors. In the example of FIG. 1, in order to set the sub-circuit 100A (or 100B) in the first operating mode, the control circuit 130 applies a logic HIGH signal (e.g., V_{DD}) to the gate terminal of the transistor 107 (e.g., an N-type CMOS transistor), a logic LOW signal (e.g., electrical ground, or zero volt) to the gate terminal of the transistor 113 (e.g., a P-type CMOS transistor), and a logic High signal (e.g., V_{DD}) to the gate terminal of the transistor 117 (e.g., a P-type CMOS transistor). As a result of the control signals applied at the gate terminals, the transistors 107 and 113 are turned on, and the transistor 117 is turned off. The states (e.g., ON or OFF) of the transistors 107, 113, and 117 are shown at their respective gate terminals in FIGS. 1, 2, and 3.

After the Zener voltage reference circuit 150 enters the startup stage for a pre-determined period of time (e.g., after the voltage between the right-side terminal and the left-side terminal of the capacitor 111 in each of the sub-circuits 100A and 100B increases to the supply voltage V_{DD}), the control circuit 130 checks an enable signal (also referred to as switching enable signal). If the enable signal is asserted, the Zener voltage reference circuit 150 enters the next operational stage, which is the switching stage, under the control of the control circuit 130. Asserting the enable signal may be achieved by changing the enable signal from a logic LOW value (e.g., zero volt) to a logic HIGH value (e.g., V_{DD}). In some embodiments, the enable signal is generated internally in the control circuit 130, e.g., by starting a timer after powering up (or a reset) and automatically asserting the enable signal after the timer times out. In another embodiment, the enable signal is generated by another circuit outside of the Zener voltage reference circuit 150 and sent to the control circuit 130 as a request to start providing reference voltage.

Next, as illustrated in FIG. 2, after the enable signal is asserted, the control circuit 130 keeps the sub-circuit 100A in the first operating mode and sets the sub-circuit 100B in a second operating mode (also referred to as Zener mode). The control circuit 130 sets the sub-circuit 100B in the second operating mode by controlling the states (e.g., closed or open) of the switches 107, 113 and 117 in the sub-circuit 100B. In particular, when a sub-circuit (e.g., 100A or 100B) is in the second operating mode, the switches 107 and 113 in the sub-circuit are open, and the switch 117 in the sub-circuit is closed. As a result, for the sub-circuit 100B, an electrical current (see the dashed line inside the sub-circuit 100B) flows from the supply voltage V_{DD}, through the capacitor 111 and the switch 117 toward the output terminal 121 of the Zener voltage reference circuit 150.

Note that in the example of FIG. 2, the voltage at the right-side terminal of the capacitor 111 in the sub-circuit 100B is at V_{DD} level at the moment when the switch 117 is closed, and the supply voltage V_{DD} is chosen to be equal to the break-down voltage V_{Z} of the Zener diode 123. In addition, the current flowing into the Zener diode 123 is higher than the minimum Zener current of the Zener diode 123. As a result, the Zener diode 123 enters the breakdown region and clamps the voltage Vₒᵤₜ at the output terminal 121 to a constant value (e.g., V_{Z}) to provide a stable output voltage for the Zener voltage reference circuit 150. Note that since the sub-circuit 100A is in the first operating mode, no current flows from the sub-circuit 100A toward the Zener diode 123.

In the illustrated embodiments, in order to set the sub-circuit 100B (or 100A) in the second operating mode (e.g., Zener mode), the control circuit 130 applies a logic LOW signal (e.g., zero volt) to the gate terminal of the transistor 107 (e.g., an N-type CMOS transistor), a logic HIGH signal (e.g., V_{DD}) to the gate terminal of the transistor 113 (e.g., a P-type CMOS transistor), and a logic LOW signal (e.g., zero volt) to the gate terminal of the transistor 117 (e.g., a P-type CMOS transistor).

In some embodiments, at the moment when the sub-circuit 100B enters the second operating mode, the voltage V_{C} at the node 105 of the sub-circuit 100B is V_{Z}−V_{DD}. Since the voltages V_{Z} and V_{DD} are chosen to be close to each other, the voltage V_{C} may have a small value (e.g., within a fraction of a volt from zero volt). As the electrical current in the sub-circuit 100B flows through the capacitor 111, the voltage V_{C} at the node 105 of the sub-circuit 100B increases. In some embodiments, the control circuit 130 monitors the voltage V_{C}, e.g., by monitoring the output of a voltage sensor. The voltage sensor may be, e.g., a comparator that compares the voltage V_{C} with a pre-determined threshold. As another example, the voltage sensor may be an analog-to-digital converter (ADC) used to convert the voltage V_{C} into a digital value for use by the control circuit 130. The voltage sensor (e.g., ADC) may be a peripheral device of the control circuit 130 (e.g., a micro-controller), thus not separately illustrated.

Next, as illustrated in FIG. 3, when the voltage V_{C} at the node 105 of the sub-circuit 100B rises above a pre-determined threshold (or equivalently, when the voltage difference V_{DD}−V_{C} falls below a pre-determined value), the control circuit 130 sets the sub-circuit 100A in the second operating mode and sets the sub-circuit 100B in the first operating mode. In other words, each of the sub-circuits 100A and 100B switches from its previous operating mode into an alternative operating mode. FIG. 3 shows the sub-circuits 100A and 100B after the switching of their operating modes as described above. Setting each of the sub-circuit 100A (or 100B) in the first operating mode or the second operating mode by the control circuit 130 has been discussed above, thus details are not repeated.

As illustrated in FIG. 3, the switch 117 in the sub-circuit 100B is open, and therefore, there is no current flowing from the sub-circuit 100B to the Zener diode 123. Instead, electrical current now flows from the sub-circuit 100A to the Zener diode 123 to keep the Zener diode 123 in the breakdown region and to maintain the output voltage Vₒᵤₜ at the break-down voltage value V_{Z}.

The control circuit 130 then monitors the voltage V_{C} at the node 105 of the sub-circuit 100A. When the voltage V_{C} at the node 105 of the sub-circuit 100A rises above a pre-determined threshold (or equivalently, when the voltage difference V_{DD}−V_{C} falls below a pre-determined value), the control circuit 130 sets the sub-circuit 100A in the first operating mode and sets the sub-circuit 100B in the second operating mode. The above operation repeats, such that during the switching stage, one of the sub-circuits 100A and 100B is in the first operating mode, and other one of the sub-circuits 100A and 100B is in the second operating mode. The sub-circuit in the second operating mode supplies electrical current to the Zener diode 123 and keeps the Zener diode 123 in the breakdown region. The sub-circuit in the first operating mode charges the capacitor 111 and acts as a backup for the sub-circuit in the second operating mode, such that when the current source 103 of the sub-circuit in the second operating mode is about to lose its ability to supply a stable current to the Zener diode 123, the sub-circuit in the first operating mode takes over and operates in the second operating mode to supply current to the Zener diode 123. Therefore, each of the sub-circuits 100A and 100B switches alternately between the first operating mode and the second operating mode, and there is always one sub-circuit (e.g., 100A or 100B) working in the second operating mode to supply current to the Zener diode 123 and keep the Zener diode 123 in the breakdown region. Skilled artisans will appreciate that in a real circuit, the time instants when the sub-circuits 100A and 100B switch their respective operating modes may not perfectly align with each other, e.g., due to mismatches in the switching speeds of the switches in the sub-circuits 100A and 100B. The misalignment in mode switching timing, which may be a few nanoseconds, a few picoseconds, or smaller, may impact the performance of the Zener voltage reference circuit 150. To overcome such performance impact, Zener voltage reference circuit with more than two sub-circuits may be used. An example Zener voltage reference circuit with four sub-circuits is discussed hereinafter.

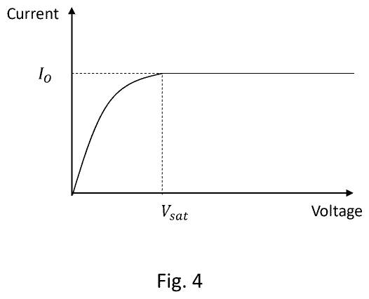

FIG. 4 illustrates the current-voltage (CV) characteristics of the current source 103, in an embodiment. In FIG. 4, the x-axis shows the voltage V_{current} for the current source 103, which corresponds to the voltage difference between the supply voltage V_{DD} and the voltage V_{C} at the node 105 (e.g., V_{current}=V_{DD}−V_{C}). The y-axis shows the current outputted by the current source 103. It is seen from FIG. 4 that when the voltage V_{current} for the current source 103 is above a saturation voltage Vₛₐₜ, the current source 103 outputs a stable current Iₒ. When the voltage V_{current} drops below the saturation voltage Vₛₐₜ, the current source 103 could no longer maintain its output current at the target value of Iₒ. Therefore, in the switching stage, the saturation voltage Vₛₐₜ can be used as the threshold for switching the operating modes of the sub-circuits 100A and 100B. For example, after a sub-circuit enters the second operating mode, the voltage V_{C} at the node 105 of the sub-circuit starts to rise. The control circuit 130 monitors the voltage V_{C} of the sub-circuit in the second operating mode. When the voltage V_{C} rises to a threshold of V_{DD}−Vₛₐₜ, or equivalently when V_{DD}−C=Vₛₐₜ, the sub-circuit is switched to operate in the first operating mode, and at the same time, the other sub-circuit (which was operating in the first operating mode) is switched to operate in the second operating mode.

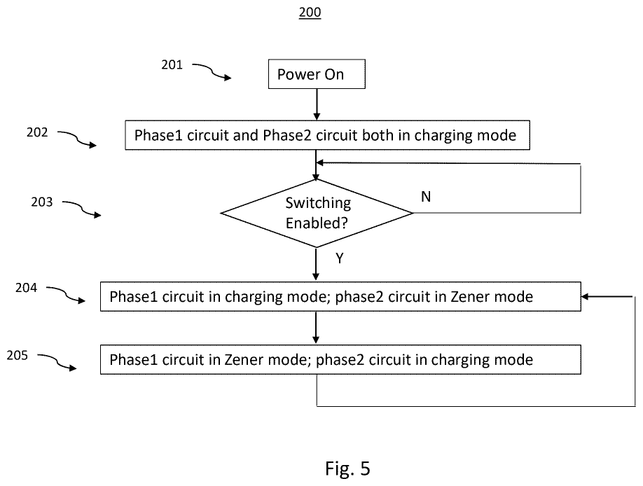

FIG. 5 illustrates the transition of the operating modes of the sub-circuits 100A and 100B in different operational stages of the Zener voltage reference circuit 150, in an embodiment.

Referring to FIG. 5, at block 201, the Zener voltage reference circuit 150 is powered up (also referred to as powered on), or is reset. At block 202, the Zener voltage reference circuit 150 enter the startup stage, where the sub-circuits 100A and 100B (also referred to as phase1 circuit and phase2 circuit, respectively) are set by the control circuit 130 to operate in the first operating mode (e.g., charging mode). At block 203, the control circuit 130 checks if an enable signal for the switching stage is asserted. If the enable signal is not asserted, the control circuit 130 waits and keeps checking. If the enable signal is asserted, the Zener voltage reference circuit 150 enters the switching stage, where the control circuit 130 keeps the phase1 circuit in the first operating mode, and switches the phase2 circuit to operate in the second operating mode (e.g., Zener mode), as shown in block 204. The control circuit 130 then monitors the voltage V_{C} at the node 105 of the phase2 circuit. At block 205, when the control circuit 130 detects that the voltage V_{C} at the node 105 of the phase2 circuit rises to a pre-determined threshold (e.g., V_{DD}−Vₛₐₜ), the control circuit 130 switches the operating modes of the phase1 circuit and the phase2 circuit. In particular, the phase1 circuit is switched to operate in the second operating mode, and the phase2 circuit is switched to operate in the first operating mode. The control circuit 130 then monitors the voltage V_{C} at the node 105 of the phase1 circuit. When the control circuit 130 detects that the voltage V_{C} at the node 105 of the phase1 circuit rises to a pre-determined threshold (e.g., V_{DD}−Vₛₐₜ), the control circuit 130 switches the operating modes of the phase1 circuit and the phase2 circuit again, such that the phase1 circuit and the phase 2 circuit operate in the first operating mode and the second operating mode, respectively. Therefore, the operating modes of the phase1 circuit and the phase2 circuit go back to those indicated in block 204. The above operation repeats, such that the phase1 circuit and phase 2 circuit switch their operating modes back-and-forth between the first operating mode and the second operating mode until, e.g., the Zener voltage reference circuit 150 is powered down, or reset.

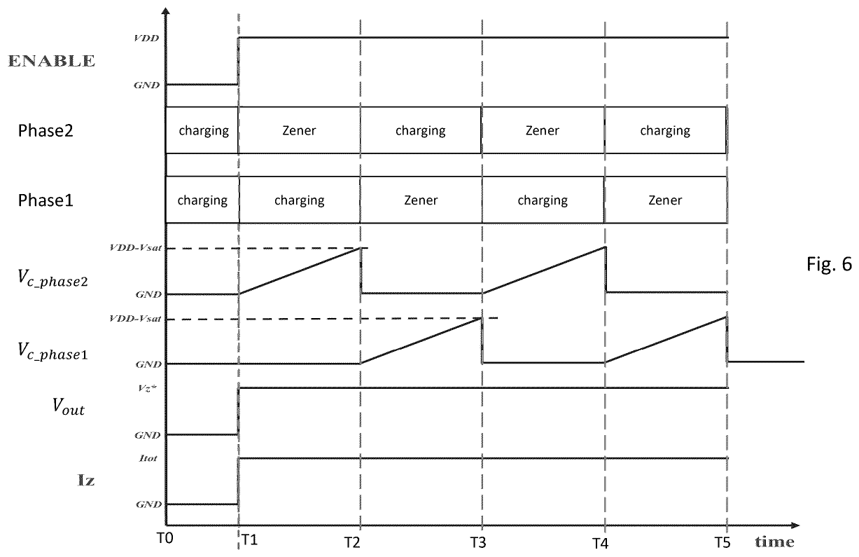

FIG. 6 illustrates a timing diagram of the Zener voltage reference circuit 150, in an embodiment. The timing diagram illustrates various signals of the Zener voltage reference circuit 150 in accordance with the operation illustrated in FIGS. 1-3 and 5. In FIG. 6, the x-axis is time, and the y-axis is the values of the various signals. The signal labeled as “ENABLE” illustrates the switching enable signal. The signals labeled as “Phase1” and “Phase2” illustrate the operating modes (e.g., charging mode or Zener mode) of the phase1 circuit and the phase2 circuit, respectively. The signals labeled as “V_{c_phase1}” and “V_{c_phase2}” illustrate the voltages V_{C} of the phase1 circuit and the phase2 circuit, respectively. The signals labeled as “Vₒᵤₜ” and “I_{Z}” illustrate the output voltage Vₒᵤₜ of the Zener voltage reference circuit 150 and the current flowing through the Zener diode 123, respectively.

As illustrated in FIG. 6, the Zener voltage reference circuit 150 is powered on at time T0. The Zener voltage reference circuit 150 is in the startup stage between time T0 and time T1, where both the phase1 circuit and the phase2 circuit operate in the charging mode. As a result, the voltages V_{C} of the phase1 circuit and the phase2 circuit are at zero volt. No current flows through the Zener diode 123, and the output voltage Vₒᵤₜ is at zero volt.

At time T1, the ENABLE signal is asserted, the Zener voltage reference circuit 150 enters the switching stage. The phase1 circuit remains in the charging mode, and the phase2 circuit now operates in the Zener mode. The Zener diode 123 is reverse biased and a current flows into the cathode of the Zener diode 123. As a result, the Zener diode 123 enters the breakdown region, and the output voltage Vₒᵤₜ rises to a clamped voltage value. The voltage V_{C} of the phase1 circuit remains at zero volt, and the voltage V_{C} of the phase2 circuit starts to rise.

At time T2, the voltage V_{C} of the phase2 circuit reaches a pre-determined threshold (e.g., V_{DD}−Vₛₐₜ), the control circuit 130 switches the operating modes of the phase1 circuit and the phase2 circuit, such that the phase1 circuit and the phase2 circuit operate in Zener mode and charging mode, respectively. As a result, the voltage V_{C} of the phase2 circuit is pulled down to zero volt, and the voltage V_{C} of the phase1 circuit starts to rise. Note that the Zener diode 123 remains in the breakdown region, and therefore, the output voltage Vₒᵤₜ and the current I_{Z} flowing through the Zener diode 123 remain unchanged.

At time T3, the voltage V_{C} of the phase1 circuit reaches a pre-determined threshold (e.g., V_{DD}−Vₛₐₜ), the control circuit 130 switches the operating modes of the phase1 circuit and the phase2 circuit again. Similar operation repeats to ensure that the phase1 circuit and the phase2 circuit keep switching their operating modes to keep the Zener diode 123 in the breakdown region.

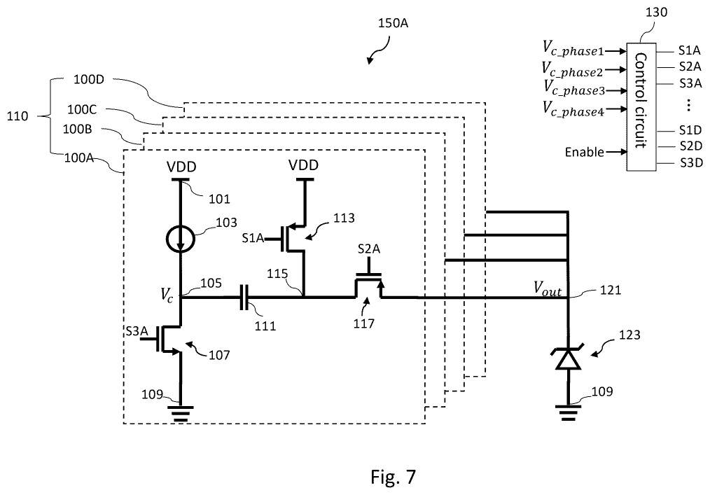

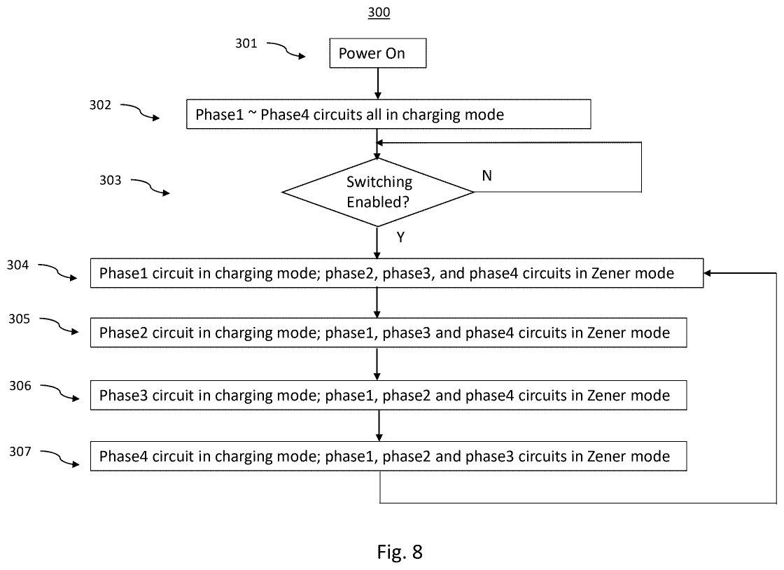

FIG. 7 illustrates a Zener voltage reference circuit 150A, in another embodiment. The Zener voltage reference circuit 150A is similar to the Zener voltage reference circuit 150, but with four sub-circuits 100A, 100B, 100C, and 100D that have the same structure as the sub-circuit 100A (or 100B) of the Zener voltage reference circuit 150. The control circuit 130 of the Zener voltage reference circuit 150A accepts as inputs the voltages V_{C} (denoted as V_{c_phase1}, V_{c_phase2}, V_{c_phase3}, and V_{c_phase4}) of the sub-circuits 100A, 100B, 100C, and 100D and the enable signal, and generates four sets of control signals, with the first set of control signals labeled as S1A, S2A, S3A, the second set of control signals labeled as S1B, S2B, and S3B, and so on, where each set of the control signals controls the switches 107, 113, and 117 of a respective sub-circuit. The sub-circuits 100A, 100B, 100C, and 100D are collectively referred to as the synchronization circuit 110 of the Zener voltage reference circuit 150A. Operation of the Zener voltage reference circuit 150A is similar to that of the Zener voltage reference circuit 150, and is discussed below with reference to FIG. 8.

FIG. 8 illustrates the transition of the operating modes of the sub-circuits 100A-100D of the Zener voltage reference circuit 150A of FIG. 7 in different operational stages, in an embodiment. In the discussion herein, the sub-circuits 100A, 100B, 100C, and 100D are also referred to as phase1 circuit, phase2 circuit, phase3 circuit, and phase4 circuit, respectively.

Referring to FIG. 8, after powering up in block 301, the Zener voltage reference circuit 150A enters the startup stage in block 302, where the phase1 circuit, the phase2 circuit, the phase3 circuit and the phase4 circuit are all set to operate in the charging mode. Next, in block 303, the control circuits 130 checks if the switching enable signal is asserted. If the switching enable signal is not asserted, the control circuits 130 waits and keeps checking. If the switching enable signal is asserted, the Zener voltage reference circuit 150A enters the switching stage. The transition of the operating modes of the sub-circuits 100A-100D are shown in blocks 304-307.

In some embodiments, when the Zener voltage reference circuit 150A is in the switching stage, each of the sub-circuits 100A-100D switches between charging mode and Zener mode alternately under the control of the control circuits 130. In some embodiments, in the switching stage, the control circuit 130 sequentially sets each one of the sub-circuits 100A-100D in charging mode, while setting the other sub-circuits in Zener mode. In other words, while one of the sub-circuits 100A-100D is operating in charging mode, the other three sub-circuits operate in Zener mode to supply electrical currents into the Zener diode 123 and keep the Zener diode 123 in the breakdown region.

In the example of FIG. 8, after the Zener voltage reference circuit 150A enters the switching stage, the control circuits 130 keeps the phase1 circuit in charging mode, and sets the phase2 circuit, the phase3 circuit, and the phase4 circuit in Zener mode, as shown in the block 304. The control circuits 130 then monitors the voltages V_{C} of the sub-circuits (e.g., the phase2 circuit, the phase3 circuit, and the phase4 circuit) operating in Zener mode. When the voltage V_{C} of one of the sub-circuits (e.g., the phase2 circuit) reaches a pre-determined threshold (e.g., V_{DD}−Vₛₐₜ), the control circuit 130 switches the operating mode of that sub-circuit into charging mode, and switches the sub-circuit (e.g., the phase1 circuit) previously operating in charging mode into Zener mode, as shown in FIG. 305. Note that as shown in block 305, the other sub-circuits (e.g., the phase3 circuit and the phase4 circuit) stay in Zener mode.

Next, as shown in the example of FIG. 8, the voltages V_{C} of the phase3 circuit reaches the pre-determined threshold (e.g., V_{DD}−Vₛₐₜ). In response, the control circuits 130 switches the phase3 circuit in charging mode, and switches the phase2 circuit into Zener mode, as shown in the block 306. Next, the voltages V_{C} of the phase4 circuit reaches the pre-determined threshold (e.g., V_{DD}−Vₛₐₜ). In response, the control circuits 130 switches the phase4 circuit in charging mode, and switches the phase3 circuit into Zener mode, as shown in the block 307.

Next, when the voltages V_{C} of the phase1 circuit reaches the pre-determined threshold (e.g., V_{DD}−Vₛₐₜ), the control circuits 130 switches the phase1 circuit in charging mode, and switches the phase4 circuit into Zener mode, the operation modes of the sub-circuits 100A-100D are back to the those shown in the block 304. The blocks 304, 305, 306, and 307 therefore illustrate a complete cycle in the switching stage, where each of the sub-circuits 100A-100D is set in the charging mode once. The switching stage may therefore comprise repeating cycles as illustrated in blocks 304-307.

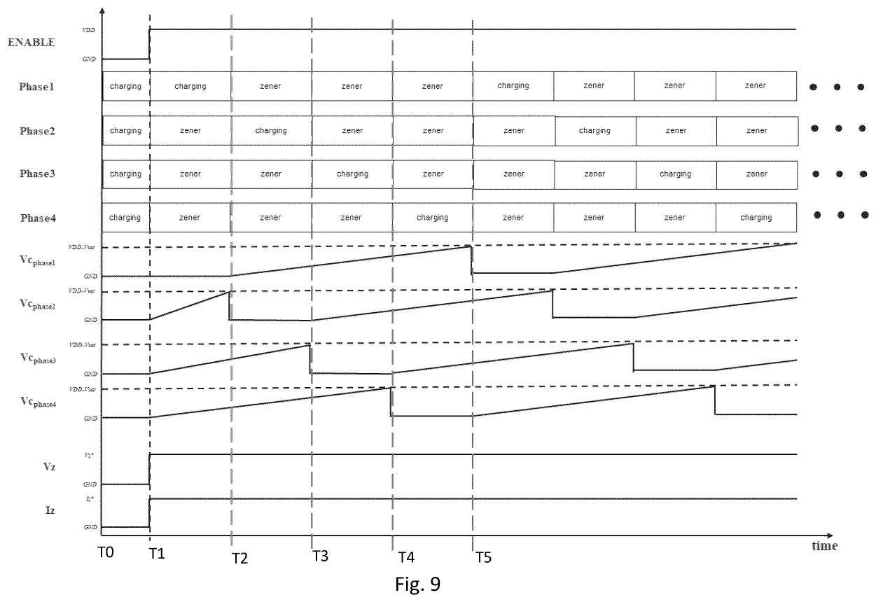

FIG. 9 illustrates a timing diagram of the Zener voltage reference circuit 150A of FIG. 7, in an embodiment. The time diagram is similar to that of FIG. 6, thus signals with the same name are not re-described. In FIG. 9, the signals labeled as “Phase1,” “Phase2,” “Phase3,” and “Phase4” illustrate the operating modes (e.g., charging mode or Zener mode) of the phase1 circuit, the phase2 circuit, the phase3 circuit, and the phase4 circuit, respectively. The signals labeled as “V_{c_phase1},” “V_{c_phase2},” “V_{c_phase3},” and “V_{c_phase4}” illustrate the voltages V_{C} of the phase1 circuit, the phase2 circuit, the phase3 circuit, and the phase4 circuit, respectively.

In FIG. 9, between time To and time T1, the Zener voltage reference circuit 150A is in the startup stage, and therefore, all of the sub-circuits are operating in charging mode. At time T1, the Zener voltage reference circuit 150A enters the switching stage, the phase1 circuit stays in charging mode, and the other sub-circuits are set to operate in Zener mode. Next, at time T2, the phase2 circuit is set to operate in charging mode, and the phase1 circuit is set to operate in Zener mode, while the other sub-circuits (e.g., the phase3 circuit and the phase4 circuit) stay in Zener mode. Next, at time T3, the phase3 circuit is set to operate in charging mode, and the phase2 circuit is set to operate in Zener mode, while the other sub-circuits (e.g., the phase1 circuit and the phase4 circuit) stay in Zener mode. Next, at time T4, the phase4 circuit is set to operate in charging mode, and the phase3 circuit is set to operate in Zener mode, while the other sub-circuits (e.g., the phase1 circuit and the phase2 circuit) stay in Zener mode. The above sequence of change in the operating modes of the sub-circuits of the Zener voltage reference circuit 150A corresponds to those illustrated in blocks 304-307 of FIG. 8.

Note that for simplicity, in the switching stage of FIG. 9, the signals “V_{c_phase1},” “V_{c_phase2},” “V_{c_phase3},” and “V_{c_phase4}” illustrate the voltages V_{C} at the steady state. Right after time T1 (when the switching enable signal is asserted), there may be a short period of time during which the signals “V_phase1,” “V_{c_phase2},” “V_{c_phase3},” and “V_{c_phase4}” settle to the steady state wave form as illustrated in FIG. 9. The transient waveforms of the signals “V_{c_phase1},” “V_{c_phase2},” “V_{c_phase3},” and “V_{c_phase4}” before the steady state are not illustrated for simplicity. During the short period of time after the time T1, the control circuit 130 may still operate with the same principle, e.g., by monitoring the voltage V_{C} of each sub-circuit, and when the voltage V_{C} of a sub-circuit reaches the pre-determined threshold, switching that sub-circuit into charging mode and switching the sub-circuit previously in charging mode into Zener mode.

Skilled artisans will readily appreciate that Zener voltage reference circuits similar to the Zener voltage reference circuits 150 and 150A may be formed using at least two sub-circuits. If the Zener voltage reference circuit includes only two sub-circuits, misalignments in the time instants when the two sub-circuits switch their respective operating modes may adversely affect the performance of the Zener voltage reference circuit. By using more than two sub-circuits, the Zener voltage reference circuit 150A may provide a more stable (e.g., smoother) current I_{Z} into the Zener diode 123 and a more stable output voltage Vₒᵤₜ than what is achievable using only two sub-circuits. For example, as illustrated in FIG. 9, during the switching stage, at any time instant when some of the sub-circuits are changing their operating modes, three other sub-circuits are already operating in Zener mode, which ensures that the Zener diode 123 is always reversely biased and there is always electrical current flowing into the cathode of the Zener diode 123 to keep the Zener diode 123 in the breakdown region. This ensures a stable output voltage Vₒᵤₜ with little or no glitches caused by the switching of the operating mode of the sub-circuits.

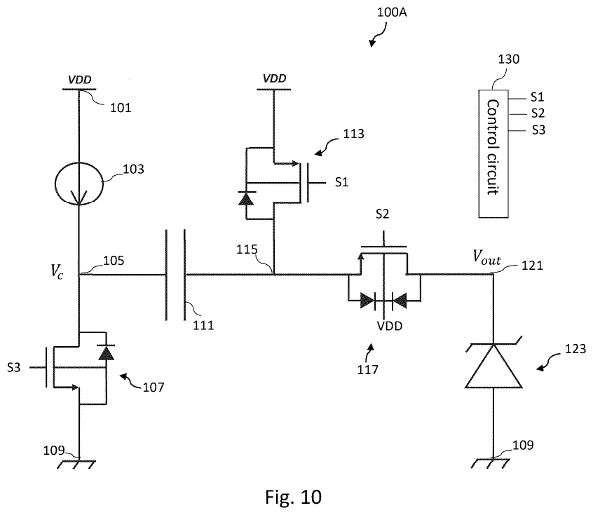

FIG. 10 illustrates the sub-circuit 100A of the Zener voltage reference circuit 150 with more details than FIG. 1, in an embodiment. In particular, the parasitic diodes (e.g., body-source diode and body-drain diode) of each of the transistors 107, 113, and 117 are illustrated in FIG. 10. Note that FIG. 10 also illustrates the Zener diode 123 and the control circuit 130 to show the electrical connection of the sub-circuit 100A, with the understanding that the Zener diode 123 and the control circuit 130 are not part of the sub-circuit 100A. For simplicity, FIG. 10 only shows the control signals (e.g., S1, S2, and S3) generated by the control circuit 130 for the sub-circuit 100A. The control circuit 130 may generate additional control signals (see, e.g., FIG. 1) for controlling other sub-circuits in the Zener voltage reference circuit.

In the example of FIG. 10, the body of the transistor 107 (or 113) is connected to its source terminal, and therefore, the body-source diode of the transistor 107 (or 113) is short-circuited, thus not illustrated. The body of the transistor 117 is connected to the supply voltage V_{DD}. Both the body-source diode and the body-drain diode of the transistor 117 are illustrated. Skilled artisans will readily appreciate that during operation of the Zener voltage reference circuit 150 (or 150A), the supply voltage V_{DD} should be higher than the breakdown voltage V_{Z} of the Zener diode 123 (which is equal to the output voltage Vₒᵤₜ). For example, if the breakdown voltage V_{Z} of the Zener diode 123 is 4.7 V, then the supply voltage V_{DD} may be 5 V. The higher supply voltage V_{DD} ensures that the body-drain diode of the transistor 117 is not forward biased during operation of the Zener voltage reference circuit 150 (or 150A), because a forward biased body-drain diode of the transistor 117 will cause a discharge current flowing from the cathode of the Zener diode 123 toward the body of the transistor 117, thus adversely affecting the operation of the Zener diodes 123 in the breakdown region.

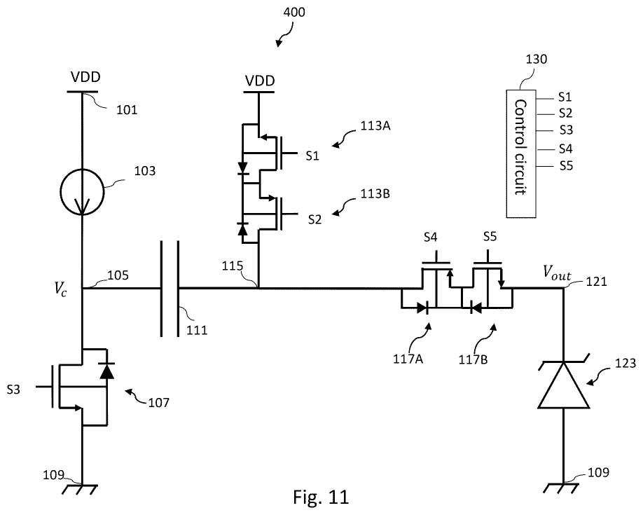

FIG. 11 illustrates a sub-circuit 400 of a Zener voltage reference circuit, in another embodiment. The sub-circuit 400 may be used to form Zener voltage reference circuits, e.g., by replacing the sub-circuits 100A and 100B in the Zener voltage reference circuit 150, or replacing the sub-circuits 100A-100D in the Zener voltage reference circuit 150A. Note that FIG. 11 further illustrates the Zener diode 123 and the control circuit 130 to show the electrical connection of the sub-circuit 400, with the understanding that the Zener diode 123 and the control circuit 130 are not part of the sub-circuit 400.

The sub-circuit 400 is similar to the sub-circuit 100A shown in FIG. 10, but with the transistor 113 replaced with transistors 113A and 113B, and with the transistor 117 replaced with transistors 117A and 117B. In particular, the transistor 113 (e.g., a P-type transistor) in FIG. 10 is replaced with the transistor 113A (e.g., an N-type transistor) and the transistor 113B (e.g., a P-type transistor). The transistors 113A and 113B are connected in series such that when both transistors 113A and 113B are turned on, an electrical current flows through the load path terminals of the transistors 113A and 113B. Similarly, the transistor 117 (e.g., a P-type transistor) in FIG. 10 is replaced with the transistor 117A (e.g., a P-type transistor) and the transistor 117B (e.g., an N-type transistor). The transistors 117A and 117B are connected in series such that when both transistors 117A and 117B are turned on, an electrical current flows through the load path terminals of the transistors 117A and 117B.

FIG. 11 further illustrates the parasitic diodes (e.g., body-drain diodes) of the transistors 107, 113A, 113B, 117A, and 117B. Note that the body-source diodes of the transistors 107, 113A, 113B, 117A, and 117B are short-circuited (due to the body of each transistor being connected to its source terminal), thus not shown. Skilled artisans will readily appreciate that the body-drain diodes of the transistors 117A and 117B are connected in an anti-series configuration (e.g., head-to-head configuration), thus preventing discharge current from flowing through. As a result, the supply voltage V_{DD} in FIG. 11 could be chosen to be a value smaller than the breakdown voltage V_{Z} of the Zener diode 123 without adversely affecting the operation of the Zener diode 123 in the breakdown region, as shown by the analysis below using some equations.

As discussed above, during the switching stage of the Zener voltage reference circuit, in order to ensure that the current source 103 is able to maintain a stable output current to keep the Zener diode 123 in the breakdown region, the following condition should be satisfied for the sub-circuit 400:

$${V}_{D D} - {V}_{C} > α \cdot {V}_{s a t} \qquad ( 1 )$$

where V_{DD} is the supply voltage, V_{C} is the voltage at the node 105, Vₛₐₜ is the saturation voltage of the current source 103, and α≥1 is a scaling factor and is used to provide some safety margin for the voltage V_{DD}−V_{C} to ensure a stable output current of the current source 103.

Denote the voltage between the right-side terminal and the left-side terminal of the capacitor 111 in FIG. 11 as V_{cap}, the following holds:

$${V}_{Z} - {V}_{cap} = {V}_{C} \qquad ( 2 )$$

where V_{Z} is the breakdown voltage of the Zener diode 123. Note that at the moment when the Zener voltage reference circuit enters the switching stage, the following holds:

$${V}_{cap} = {V}_{DD} \qquad ( 3 )$$

From equations (1), (2), and (3), the following can be derived:

$${V}_{DD} > \frac{{V}_{Z} + α \cdot {V}_{sat}}{2} \qquad ( 4 )$$

Since the saturation voltage Vₛₐₜ typically has a small value, Equation (4) shows that the supply voltage V_{DD} can be chosen to have a value smaller than the breakdown voltage V_{Z} of the Zener diode 123. As a result, transistors (e.g., COMS transistors) with low voltage ratings can be used as the switches 107, 113, and 117 in FIG. 11.

FIG. 11 illustrates the control signals S1, S2, S3, S4, and S5 that the control circuit 130 generates for controlling the transistors 113A, 113B, 107, 117A, and 117B, respectively. The control circuits 130 may generates other control signals for other sub-circuits of the Zener voltage reference circuit. In the example of FIG. 11, to set the sub-circuit 400 in charging mode, the control signal S1, S2, S3, S4, and S5 have voltage values of 2·V_{DD}, 0, V_{DD}, V_{DD}, and V_{DD}, respectively. As a result, the transistors 107, 113A, and 113B are turned on, and the transistors 117A and 117B are turned off in charging mode. Conversely, to set the sub-circuit 400 in Zener mode, the control signal S1, S2, S3, S4, and S5 have voltage values of V_{DD}, V_{DD}, 0, 0, and 2·V_{DD}, respectively. As a result, the transistors 107, 113A, and 113B are turned off, and the transistors 117A and 117B are turned on in Zener mode. Operation of the Zener voltage reference circuit built using the sub-circuit 400 is the same as or similar to those discussed above, thus details are not repeated.

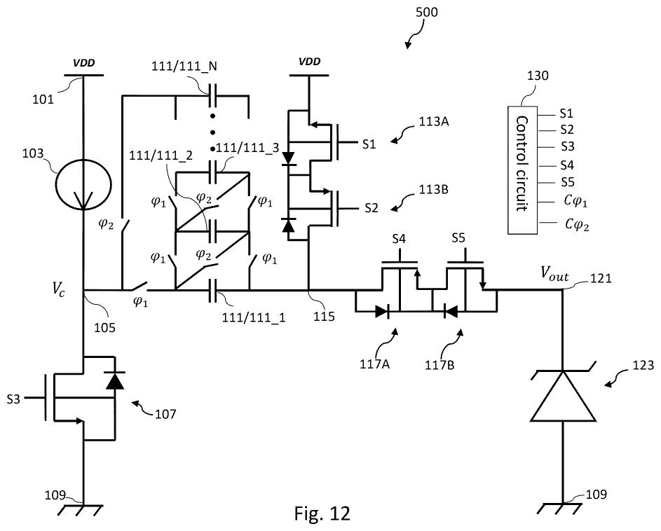

FIG. 12 illustrates a sub-circuit 500 of a Zener voltage reference circuit, in yet another embodiment. The sub-circuit 500 may be used to form Zener voltage reference circuits, e.g., by replacing the sub-circuits 100A and 100B in the Zener voltage reference circuit 150, or replacing the sub-circuits 100A-100D in the Zener voltage reference circuit 150A. Note that FIG. 12 further illustrates the Zener diode 123 and the control circuit 130 to show the electrical connection of the sub-circuit 500, with the understanding that the Zener diode 123 and the control circuit 130 are not part of the sub-circuit 500.

The sub-circuit 500 is similar to the sub-circuit 400 shown in FIG. 11, but with the capacitor 111 in FIG. 11 replaced with a plurality of capacitors 111_1, 111_2, . . . , and 111_N. The plurality of capacitors 111_1, 111_2, . . . , and 111_N may be collectively referred to as capacitors 11. The capacitors 111 in FIG. 12 are coupled between the node 105 and the node 115, and are connected to a first plurality of switches φ₁ and a second plurality of switches φ₂. The first plurality of switches φ₁ are closed or opened under the control of a same control signal Cφ₁ generated by the control circuit 130. The second plurality of switches φ₂ are closed or opened under the control of a same control signal Cφ₂ generated by the control circuit 130. The plurality of capacitors 111, the first plurality of switches φ₁, and the second plurality of switches φ₂ are collectively referred to as a re-configurable capacitor bank, where the capacitors in the re-configurable capacitor bank can be re-configured to be coupled in parallel or in series. The control circuit 130 also generates control signals S1, S2, S3, S4, and S5 for controlling the transistors 113A, 113B, 107, 117A, and 117B, respectively.

In the illustrated example of FIG. 12, to set the sub-circuit 500 in charging mode, the control circuit 130 closes the first plurality of switches φ₁ and opens the second plurality of switches φ₂. As a result, the capacitors 111 are coupled in parallel between the node 105 and the node 115. In addition, the control circuit 130 turns on the transistors 107, 113A, and 113B, and turns off the transistors 117A and 117B. The values of the control signals S1, S2, S3, S4, and S5 for setting the sub-circuit 500 in charging mode and Zener mode are the same as those discussed above for the sub-circuit 400, thus not repeated.

In charging mode, the capacitors 111 of the sub-circuit 500 are coupled in parallel, and are charged by the current flowing from the supply voltage V_{DD}, through the transistors 113A and 113B, through the capacitors 111, through the transistor 107, and toward the reference voltage node 109. Note that the voltage V_{cap} of each of the capacitors 111 reach the value V_{DD} after being charged for a period of time in charging mode.

Still referring to FIG. 12, to set the sub-circuit 500 in Zener mode, the control circuit 130 opens the first plurality of switches φ₁ and closes the second plurality of switches φP₂. As a result, the capacitors 111 are coupled in series between the node 105 and the node 115. In addition, the control circuit 130 turns off the transistors 107, 113A, and 113B, and turns on the transistors 117A and 117B.

In Zener mode, the capacitors 111 of the sub-circuit 500 are coupled in series, and therefore, the voltage difference between the node 115 and the node 105 is N·V_{cap}, where N is number of capacitors in the plurality of capacitors 111. In other words, for the sub-circuit 500, the voltage V_{C} at the node 105 in Zener mode is:

$${V}_{Z} - N \cdot {V}_{cap} = {V}_{cC} \qquad ( 5 )$$

Replacing Equation (2) above with Equation (5), the following can be derived using equations (1), (5), and (3):

$${V}_{DD} > \frac{{V}_{Z} + α \cdot {V}_{sat}}{1 + N} \qquad ( 6 )$$

Therefore, the sub-circuit 500 allows the supply voltage V_{DD} to have a value smaller than the breakdown voltage V_{Z} of the Zener diode 124, and smaller than what is allowed for the sub-circuit 400. Operation of the Zener voltage reference circuit built using the sub-circuit 500 is the same as or similar to those discussed above, thus details are not repeated.

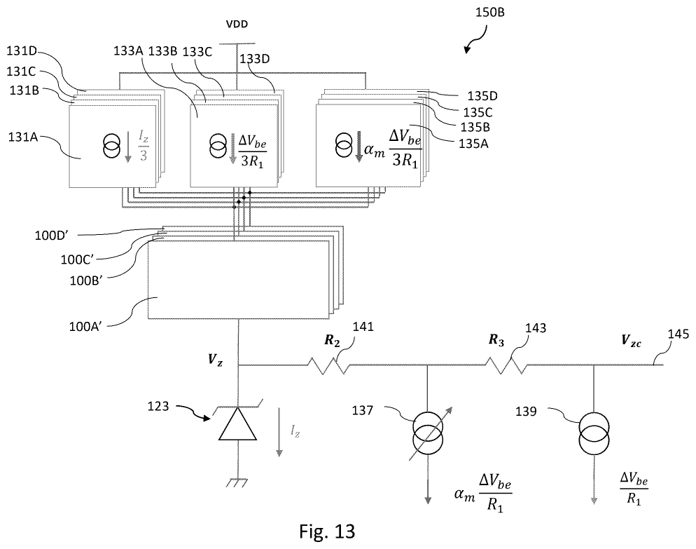

FIG. 13 illustrates a Zener voltage reference circuit 150B with temperature compensation capability, in an embodiment. In FIG. 13, each of the blocks 100A′, 100B′, 100C′, and 100D′ corresponds to an implementation of a same sub-circuit disclosed herein, such as the sub-circuit 100A, 400, or 500, but without the current source 103. Note that during the switching stage operation, three of the four sub-circuits 100A′, 100B′, 100C′, and 100D′ work in Zener mode (thus supplying currents to the Zener diode 123) while another sub-circuit works in charging mode (thus not supplying current to the Zener diode 123). Assume that in the switching stage, the nominal total current supplied from all of the four sub-circuits (or equivalently, the three sub-circuits in Zener mode) to the Zener diode 123 is I_{Z}, the contribution (e.g., total current) from the current sources of all of the four sub-circuits to the Zener diode 123 is modeled by four identical current sources 131A, 131B, 131C and 131D (collectively referred to as current sources 131), four identical current sources 133A, 133B, 133C and 133D (collectively referred to as current sources 133), and four identical current sources 135A, 135B, 135C and 135D (collectively referred to as current sources 135) connected in parallel in FIG. 13. Each sub-circuit 100A′, 100B′, 100C′, or 100D′ is connected to one of the four current sources 131, one of the four current sources 133, and one of the four current sources 135. Each of the current sources 131 represents an ideal current source that outputs a constant current output I_{Z}/3. The current sources 133 model the temperature-dependent portions of the currents provided to the Zener diode 123, and the output of each of the current sources 133 is denoted as

$$\frac{Δ {V}_{b e}}{3 {R}_{1}} ,$$

where ΔV_{be} models a voltage that changes (e.g., linearly) with temperature, and R₁ is an equivalent resistance to convert the voltage ΔV_{be} into a current. The parameters ΔV_{be} and R₁ are inherent parameters of the current sources of the sub-circuits, and may be determined by, e.g., analyzing the current sources, simulations, and/or by performing a characterization/measurement process for the current sources. The current sources 135 model the adjustable portions of the currents provided to the Zener diode 123, where each of the current sources 135 generates an output current denoted as

$${α}_{m} \frac{{ΔV}_{be}}{3 {R}_{1}}$$

where αₘ is a scaling factor that will be determined as demonstrated below, and is used to help achieving a temperature-compensated voltage output V_{ZC}. The scaling factor αₘ may be implemented as a trim code of the current source 135, and once the optimum or near-optimum value of the αₘ is determined, the trim code can be set through a trimming process.

In the example of FIG. 13, the blocks 100A′, 100B′, 100C′, 100D′ and the current sources 131 are functionally equivalent to four sub-circuits of a Zener voltage reference circuit similar to the Zener voltage reference circuit 150A. The current sources 133 and 135 in FIG. 13 are added for temperature compensation. Note that in switching stage, at any time, three of the four sub-circuits are in Zener mode and are supplying currents to the Zener diode 123. Therefore, the current sources 133 and 135 equivalently add a current source of

$$\frac{Δ {V}_{b e}}{3 {R}_{1}}$$

and a current source of

$${α}_{m} \frac{Δ {V}_{b e}}{3 \cdot {R}_{1}}$$

in parallel to the current source 103 in each of the four sub-circuits of the Zener voltage reference circuit 150A.

The temperature-compensated output voltage V_{ZC} of the Zener voltage reference circuit 150B is generated by passing the output voltage at the cathode of the Zener diode 123, which is denoted as V_{Z} in FIG. 13, through a compensation network comprising a current source 137, a current source 139, a resistor 141, and a resistor 143. The output of the current source 137 is

$${α}_{m} \frac{Δ {V}_{b e}}{{R}_{1}} ,$$

where the scaling factor αₘ may be implemented as a trim code of the current source 137, and the output of the current source 139 is

$$\frac{Δ {V}_{b e}}{{R}_{1}} .$$

The resistance of the resistors 141 and 143 are R₂ and R₃, respectively. The temperature-dependent output voltage V_{Z} is represented as:

$${V}_{z} ( T ) = {V}_{Z 0} + {TC}_{z} \cdot T \qquad ( 7 )$$

where V_{Z0} represents the constant portion of the output voltage, TC_{z} is the thermal coefficient of the Zener diode 123, and T is the temperature. The temperature-compensated voltage V_{zc}(T) at the output terminal 145 of the Zener voltage reference circuit 150B is given by:

$${V}_{zc} ( T ) = {V}_{Z} ( T ) - {R}_{2} \cdot ( {α}_{m} \frac{Δ {V}_{b e}}{{R}_{1}} + \frac{Δ {V}_{b e}}{{R}_{1}} ) - {R}_{3} \cdot \frac{Δ {V}_{b e}}{{R}_{1}} \qquad ( 8 )$$

To find the scaling factor αₘ that achieves a constant temperature-compensated voltage V_{zc}(T), one needs to solve the following:

$$\frac{\partial {V}_{z c} ( T )}{\partial T} = O \qquad ( 9 )$$

Solving Equation (9) yields the optimum value for the scaling factor αₘ:

$${α}_{m} = ( {TC}_{z} - \frac{slope ( Δ {V}_{b e} )}{{R}_{1}} \cdot ( {R}_{2} + {R}_{3} ) ) \cdot \frac{{R}_{1}}{{R}_{2} \cdot slope ( Δ {V}_{b e} )} \qquad ( 10 )$$

where slope (ΔV_{be}) is the gradient of ΔV_{be} with respect to temperature T. As mentioned above, the αₘ value is used to trim the current sources 135 and 139.

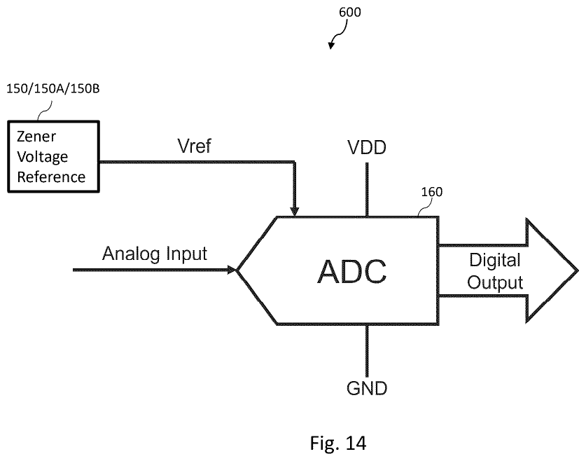

FIG. 14 illustrates an analog-to-digital converter (ADC) system 600 using a Zener voltage reference circuit, in an embodiment. The Zener voltage reference circuit may be any of the Zener voltage reference circuit disclosed herein, such as 150, 150A, or 150B. The ADC system 600 includes an ADC 160. The ADC 160 is powered by a supply voltage V_{DD}, and receives a reference voltage V_{ref} from the Zener voltage reference circuit. The reference voltage V_{ref} is the output voltage (e.g., Vₒᵤₜ or V_{ZC}) of the Zener voltage reference circuit. The ADC 160 uses the reference voltage V_{ref} in the conversion of an analog input signal into digital output values.

Advantages are achieved by the disclosed embodiments. For example, in a Zener voltage reference circuit, the generated output voltage is typically equal to a breakdown voltage V_{Z} of a heavily doped P-N junction, which is often in the range of 5.3 V to 6.5 V to minimize temperature drift. In conventional Zener voltage reference circuit designs, an auxiliary supply voltage higher than the breakdown voltage V_{Z} is often needed to drive the circuit. This means that the voltage rating of the transistors in conventional Zener reference voltage circuits is higher than that of CMOS transistors. For instance, for a Zener diode with a breakdown voltage of 5.3 V, MOSFETs with voltage rating of 15 V may be used in conventional Zener voltage reference circuits. If the auxiliary supply voltage is generated by an auxiliary voltage supply circuit implemented as part of the conventional Zener voltage reference circuits, the auxiliary voltage supply circuit may result in extra power consumption and larger device size. In addition, MOSFET with higher voltage rating may be more expensive and may require more physical space to implement than CMOS transistors. The present disclosure allows transistors (e.g., CMOS transistors) with low voltage rating to be used as the switches 107, 113, and 117 of the Zener voltage reference circuit, and there is no need to use an auxiliary supply voltage. As a result, the disclosed Zener voltage reference circuits are simple, inexpensive to implement, and may consume less power. Furthermore, temperature-compensation can be achieved for the disclosed Zener voltage reference circuit to provide stable output voltage against temperature variation.

Example embodiments of the present invention are summarized here. Other embodiments can also be understood from the entirety of the specification and the claims filed herein.

Example 1. In accordance with an embodiment, a voltage reference circuit includes: a Zener diode and a synchronization circuit coupled to a cathode of the Zener diode. The synchronization circuit includes a first circuit and a second circuit, where each of the first circuit and second circuit includes: a current source coupled between a supply voltage node and a first node; a first switch coupled between the first node and a reference voltage node; a first capacitor coupled between the first node and a second node; a second switch coupled between the second node and the supply voltage node; and a third switch coupled between the second node and the cathode of the Zener diode.

Example 2. The voltage reference circuit of Example 1, further comprising a control circuit, wherein the control circuit is configured to, during a switching stage of the voltage reference circuit, switch each of the first circuit and the second circuit between a first operating mode and a second operating mode alternately.

Example 3. The voltage reference circuit of Example 2, wherein the control circuit is configured to, during the switching stage of the voltage reference circuit: set the first circuit and the second circuit in the first operating mode and the second operating mode, respectively, for a first duration of time; and set the first circuit and the second circuit in the second operating mode and the first operating mode, respectively, for a second duration of time different from the first duration of time.

Example 4. The voltage reference circuit of Example 2, wherein the control circuit is configured to: set each of the first circuit and the second circuit in the first operating mode by closing the first switch and the second switch and opening the third switch; and set each of the first circuit and the second circuit in the second operating mode by opening the first switch and the second switch and closing the third switch.

Example 5. The voltage reference circuit of Example 2, wherein the control circuit is configured to, during a startup stage of the voltage reference circuit different from the switching stage of the voltage reference circuit, set the first circuit and the second circuit in the first operating mode for a third duration of time.

Example 6. The voltage reference circuit of Example 5, wherein the startup stage precedes the switching stage.

Example 7. The voltage reference circuit of Example 2, wherein during the switching stage of the voltage reference circuit, the control circuit is configured to, after setting the first circuit and the second circuit in the first operating mode and the second operating mode, respectively: monitor a voltage difference between a supply voltage applied at the supply voltage node of the second circuit and a voltage at the first node of the second circuit; and in response to detecting that the voltage difference decreases to a pre-determined value, set the second circuit in the first operating mode.

Example 8. The voltage reference circuit of Example 2, wherein the first switch is a first N-type transistor, the second switch is a first P-type transistor, and the third switch is a second P-type transistor.

Example 9. The voltage reference circuit of Example 8, wherein each of the first circuit and the second circuit further comprises: a second N-type transistor coupled in series with the first P-type transistor between the second node and the supply voltage node; and a third N-type transistor coupled in series with the second P-type transistor between the second node and the cathode of the Zener diode.

Example 10. The voltage reference circuit of Example 9, wherein for each of the first circuit and the second circuit, the control circuit is configured to turn ON and OFF the first P-type transistor and the second N-type transistor at a same time, and is configured to turn ON and OFF the second P-type transistor and the third N-type transistor at a same time.

Example 11. The voltage reference circuit of Example 9, wherein each of the first circuit and the second circuit further comprises: a second capacitor; a fourth switch coupled between the first node and a first terminal of the first capacitor; a fifth switch coupled between the first terminal of the first capacitor and a first terminal of the second capacitor; a sixth switch coupled between a second terminal of the first capacitor and a second terminal of the second capacitor; a seventh switch coupled between the first terminal of the first capacitor and the second terminal of the second capacitor; and an eighth switch coupled between the first node and the first terminal of the second capacitor.

Example 12. The voltage reference circuit of Example 11, wherein the control circuit is configured to: set each of the first circuit and the second circuit in the first operating mode by closing the first switch, the second switch, the fourth switch, the fifth switch, and the sixth switch and opening the third switch, the seventh switch, and the eighth switch; and set each of the first circuit and the second circuit in the second operating mode by opening the first switch, the second switch, the fourth switch, the fifth switch, and the sixth switch and closing the third switch, the seventh switch, and the eighth switch.

Example 13. In accordance with an embodiment, a voltage reference circuit includes: a synchronization circuit, wherein the synchronization circuit comprises a plurality of sub-circuits, wherein each of the sub-circuits comprises: a current source coupled between a supply voltage node and a first node; a first switch coupled between the first node and a reference voltage node; a capacitor coupled between the first node and a second node; a second switch coupled between the second node and the supply voltage node; and a third switch coupled between the second node and an output terminal of the synchronization circuit. The voltage reference circuit further includes a Zener diode coupled between the output terminal of the synchronization circuit and the reference voltage node.

Example 14. The voltage reference circuit of Example 13, further comprising a control circuit, wherein the control circuit is configured to, during a switching stage of the voltage reference circuit, switch each of the plurality of sub-circuits between a first operating mode and a second operating mode alternately.

Example 15. The voltage reference circuit of Example 14, wherein during the switching stage of the voltage reference circuit, the control circuit is configured to set each of the plurality of sub-circuits in the first operating mode at a different time interval.

Example 16. The voltage reference circuit of Example 14, wherein the control circuit is configured to: set each of the plurality of sub-circuits in the first operating mode by closing the first switch and the second switch and opening the third switch; and set each of the plurality of sub-circuits in the second operating mode by opening the first switch and the second switch and closing the third switch.

Example 17. The voltage reference circuit of Example 14, wherein the control circuit is configured to, before entering the switching stage, set the plurality of sub-circuits in the first operating mode for a period of time.

Example 18. In accordance with an embodiment, a method of operating a voltage reference circuit is disclosed. The voltage reference circuit comprises a synchronization circuit and a Zener diode coupled to an output terminal of the synchronization circuit, where the synchronization circuit comprises a plurality of sub-circuits. The method includes: setting the plurality of sub-circuits in a first operating mode for a first duration of time, wherein each of the sub-circuits comprises: a current source coupled between a supply voltage and a first node; a first switch coupled between the first node and a reference voltage; a capacitor coupled between the first node and a second node; a second switch coupled between the second node and the supply voltage; and a third switch coupled between the second node and the output terminal of the synchronization circuit, wherein setting the plurality of sub-circuits in the first operating mode comprises, for each of the plurality of sub-circuits, closing the first switch and the second switch and opening the third switch. The method further includes, after the first duration of time elapses, switching each of the plurality of sub-circuits between the first operating mode and a second operating mode alternately, wherein each of the plurality of sub-circuits is set in the second operating mode by opening the first switch and the second switch and closing the third switch.

Example 19. The method of Example 18, wherein switching each of the plurality of sub-circuits comprises setting each of the plurality of sub-circuits in the first operating mode at a different time interval.

Example 20. The method of Example 18, wherein switching each of the plurality of sub-circuits comprises: monitoring, for each of the plurality of sub-circuits, a voltage difference between the supply voltage and a first voltage at the first node; and in response to detecting that the voltage difference of a sub-circuit of the plurality of sub-circuits is below a pre-determined threshold, setting the sub-circuit to the first operating mode.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A voltage reference circuit comprising:
a Zener diode; and
a synchronization circuit coupled to a cathode of the Zener diode, wherein the synchronization circuit comprises a first circuit and a second circuit, wherein each of the first circuit and second circuit comprises:
a current source coupled between a supply voltage node and a first node;
a first switch coupled between the first node and a reference voltage node;
a first capacitor coupled between the first node and a second node;
a second switch coupled between the second node and the supply voltage node; and
a third switch coupled between the second node and the cathode of the Zener diode.

2. The voltage reference circuit of claim 1, further comprising a control circuit, wherein the control circuit is configured to, during a switching stage of the voltage reference circuit, switch each of the first circuit and the second circuit between a first operating mode and a second operating mode alternately.

3. The voltage reference circuit of claim 2, wherein the control circuit is configured to, during the switching stage of the voltage reference circuit:
set the first circuit and the second circuit in the first operating mode and the second operating mode, respectively, for a first duration of time; and
set the first circuit and the second circuit in the second operating mode and the first operating mode, respectively, for a second duration of time different from the first duration of time.

4. The voltage reference circuit of claim 2, wherein the control circuit is configured to:
set each of the first circuit and the second circuit in the first operating mode by closing the first switch and the second switch and opening the third switch; and
set each of the first circuit and the second circuit in the second operating mode by opening the first switch and the second switch and closing the third switch.

5. The voltage reference circuit of claim 2, wherein the control circuit is configured to, during a startup stage of the voltage reference circuit different from the switching stage of the voltage reference circuit, set the first circuit and the second circuit in the first operating mode for a third duration of time.

6. The voltage reference circuit of claim 5, wherein the startup stage precedes the switching stage.

7. The voltage reference circuit of claim 2, wherein during the switching stage of the voltage reference circuit, the control circuit is configured to, after setting the first circuit and the second circuit in the first operating mode and the second operating mode, respectively:
monitor a voltage difference between a supply voltage applied at the supply voltage node of the second circuit and a voltage at the first node of the second circuit; and
in response to detecting that the voltage difference decreases to a pre-determined value, set the second circuit in the first operating mode.

8. The voltage reference circuit of claim 2, wherein the first switch is a first N-type transistor, the second switch is a first P-type transistor, and the third switch is a second P-type transistor.

9. The voltage reference circuit of claim 8, wherein each of the first circuit and the second circuit further comprises:
a second N-type transistor coupled in series with the first P-type transistor between the second node and the supply voltage node; and
a third N-type transistor coupled in series with the second P-type transistor between the second node and the cathode of the Zener diode.

10. The voltage reference circuit of claim 9, wherein for each of the first circuit and the second circuit, the control circuit is configured to turn ON and OFF the first P-type transistor and the second N-type transistor at a same time, and is configured to turn ON and OFF the second P-type transistor and the third N-type transistor at a same time.

11. The voltage reference circuit of claim 9, wherein each of the first circuit and the second circuit further comprises:
a second capacitor;
a fourth switch coupled between the first node and a first terminal of the first capacitor;
a fifth switch coupled between the first terminal of the first capacitor and a first terminal of the second capacitor;
a sixth switch coupled between a second terminal of the first capacitor and a second terminal of the second capacitor;
a seventh switch coupled between the first terminal of the first capacitor and the second terminal of the second capacitor; and
an eighth switch coupled between the first node and the first terminal of the second capacitor.

12. The voltage reference circuit of claim 11, wherein the control circuit is configured to:
set each of the first circuit and the second circuit in the first operating mode by closing the first switch, the second switch, the fourth switch, the fifth switch, and the sixth switch and opening the third switch, the seventh switch, and the eighth switch; and
set each of the first circuit and the second circuit in the second operating mode by opening the first switch, the second switch, the fourth switch, the fifth switch, and the sixth switch and closing the third switch, the seventh switch, and the eighth switch.

13. A voltage reference circuit comprising:
a synchronization circuit, wherein the synchronization circuit comprises a plurality of sub-circuits, wherein each of the sub-circuits comprises:
a current source coupled between a supply voltage node and a first node;
a first switch coupled between the first node and a reference voltage node;
a capacitor coupled between the first node and a second node;
a second switch coupled between the second node and the supply voltage node; and
a third switch coupled between the second node and an output terminal of the synchronization circuit; and
a Zener diode coupled between the output terminal of the synchronization circuit and the reference voltage node.

14. The voltage reference circuit of claim 13, further comprising a control circuit, wherein the control circuit is configured to, during a switching stage of the voltage reference circuit, switch each of the plurality of sub-circuits between a first operating mode and a second operating mode alternately.

15. The voltage reference circuit of claim 14, wherein during the switching stage of the voltage reference circuit, the control circuit is configured to set each of the plurality of sub-circuits in the first operating mode at a different time interval.

16. The voltage reference circuit of claim 14, wherein the control circuit is configured to:
set each of the plurality of sub-circuits in the first operating mode by closing the first switch and the second switch and opening the third switch; and
set each of the plurality of sub-circuits in the second operating mode by opening the first switch and the second switch and closing the third switch.

17. The voltage reference circuit of claim 14, wherein the control circuit is configured to, before entering the switching stage, set the plurality of sub-circuits in the first operating mode for a period of time.

18. A method of operating a voltage reference circuit comprising a synchronization circuit and a Zener diode coupled to an output terminal of the synchronization circuit, wherein the synchronization circuit comprises a plurality of sub-circuits, wherein the method comprises:
setting the plurality of sub-circuits in a first operating mode for a first duration of time, wherein each of the sub-circuits comprises:
a current source coupled between a supply voltage and a first node;
a first switch coupled between the first node and a reference voltage;
a capacitor coupled between the first node and a second node;
a second switch coupled between the second node and the supply voltage; and
a third switch coupled between the second node and the output terminal of the synchronization circuit, wherein setting the plurality of sub-circuits in the first operating mode comprises, for each of the plurality of sub-circuits, closing the first switch and the second switch and opening the third switch; and
after the first duration of time elapses, switching each of the plurality of sub-circuits between the first operating mode and a second operating mode alternately, wherein each of the plurality of sub-circuits is set in the second operating mode by opening the first switch and the second switch and closing the third switch.

19. The method of claim 18, wherein switching each of the plurality of sub-circuits comprises setting each of the plurality of sub-circuits in the first operating mode at a different time interval.

20. The method of claim 18, wherein switching each of the plurality of sub-circuits comprises:
monitoring, for each of the plurality of sub-circuits, a voltage difference between the supply voltage and a first voltage at the first node; and
in response to detecting that the voltage difference of a sub-circuit of the plurality of sub-circuits is below a pre-determined threshold, setting the sub-circuit to the first operating mode.
